(19) United States
(12) Patent Application Publication
(10) Pub. No.: US 2007/0293198 A1
(43) Pub. Date: Dec. 20, 2007

(54) SYSTEM AND METHOD FOR TARGETED ADVERTISING

(76) Inventors: Sivakumaran Sanmugasuntharam, Markham (CA); Anton Mendoza, Etobicoke (CA); Mamoon Rashid, Mississauga (CA)

Correspondence Address: BLAKE, CASSELS & GRAYDON, LLP, 45 O'CONNOR ST., 20TH FLOOR, OTTAWA, ON, K1P 1A4, CA

(21) Appl. No.: 11/740,406

(22) Filed: Apr. 26, 2007

Related U.S. Application Data
(60) Provisional application No. 60/745,880, filed on Apr. 28, 2006.
(60) Provisional application No. 60/746,282, filed on May 3, 2006.

(51) Int. Cl. H04M 3/42

(52) U.S. Cl. 455/414.1

(57) ABSTRACT

A method and system for targeting advertising content to a user of a telecommunication system is provided. Information related to users of a particular service offered by the telecommunication system is gathered and used to create a user profile for each user, which is stored by an advertising system. The user profiles are used, along with analysis of communications made by the user, to correlate advertising content to a particular demographic that likely includes that user. The advertising content is presented to the user before, during or following a communication, typically using an interface on a device used to perform the communication.

This application claims the benefit of U.S. Provisional Patent Application Ser. No. 60/745,880 filed Apr. 28, 2006 and U.S. Provisional Patent Application Ser. No. 60/746,282 filed May 3, 2006, the complete disclosure of which is hereby expressly incorporated by reference.

### FIELD OF TECHNOLOGY

The present invention relates generally to the field of telecommunications and has particular utility in providing targeted advertising to users in a telecommunication system.

### DESCRIPTION OF THE PRIOR ART

Telecommunication services are continually becoming integrated with networks such as the Internet and users who subscribe to such services often expect to obtain access to the service at little or no cost. In order to cover some or all of the cost for providing a service such as access to the Internet, service providers are known to provide advertising along with the service, whereby revenue generated from the advertising can offset or even completely cover the cost of providing the service.

It is often difficult to determine which advertisers and advertisements are most suitable for complementing the service. For example, advertisements that are suitable for older audiences may not have the same effect on a young consumer if the content of the advertisement is not relevant to consumers of that age. Advertisers may become reluctant to advertise through an Internet service if they believe that the content is not being noticed and/or is not being directed to the intended audience.

It is therefore an object of the following to obviate or mitigate the above disadvantages.

### SUMMARY

In one aspect, there is provided a method for providing advertising to a user in a telecommunication system. The method comprises obtaining information related to the user; assigning one or more identifier to the user based on the nature of the information; identifying an advertisement applicable to the user based on at least one of the one or more identifier; and providing the advertisement to the user using the telecommunication system.

### BRIEF DESCRIPTION OF THE DRAWINGS

An embodiment of the invention will now be described by way of example only with reference to the appended drawings wherein:

FIG. 1 is a schematic representation of a telecommunication system;

FIG. 2 is a schematic representation of a graphical user interface (GUI) for connecting to the telecommunication system of FIG. 1;

FIG. 3 is a flow chart illustrating steps for providing an advertisement to a user of FIG. 1 in one embodiment;

FIG. 4 is a flow chart illustrating steps for creating a user profile;

FIG. 5 is a flow chart illustrating steps for determining a suitable advertisement; and

FIG. 6 is a schematic representation of a user profile.

### DETAILED DESCRIPTION

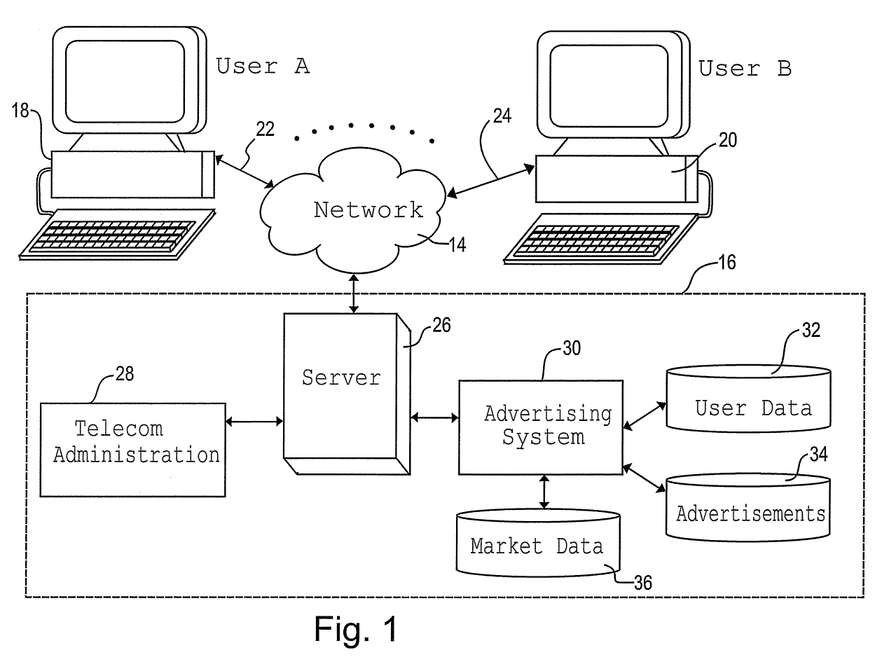

Referring therefore to FIG. 1, a first user (hereinafter “User A”) utilizing a first personal computer (PC) 18 communicates with a second user (hereinafter “User B”) utilizing a second PC 20 over a network 14. Typically, User A and User B are located in different geographical areas served by the network 14. It will be appreciated that the functions performed by the PCs 18, 20 can also be accomplished using any suitable device, such as an Analog Telephony Adaptor (ATA) device used with a telephone, whereby a phone display is capable to displaying text or video to a user.

User A connects to the network 14 through PC 18 using a connection 22 and User B connects to the network through PC 20 using a connection 24. The connections 22 and 24 may be provided by any suitable means for connecting to the infrastructure used by the network 14, e.g. any wireless or hard-wired link between the users and the infrastructure.

User A and User B utilize one or more services provided by a telecommunication system 16 such as Internet access, Voice over Internet Protocol (VoIP), television services etc. In the present example, the telecommunication system 16 is an Internet Service Provider (ISP) that provides Internet-based services to User A and User B, in particular a VoIP telephone service.

The system 16 comprises a server 26 for hosting Internet-based services provided using the network 14, in particular, the server 26 is used to monitor and control access to the services, e.g., billing, registration etc. The system 16 also comprises a telecommunications administrator 28 for controlling the distribution of the Internet-based services. The system 16 also comprises an advertising system 30 for providing targeted advertising content to the users of the telecommunication system 16. The advertising system 30 utilizes a user database 32 for storing user profiles for each user registered with the telecommunication system 16, an advertisement database 34 for storing advertising content to be provided to the users, and a market database 36 for storing market data that is used for correlating information related to a user to suitable advertisement content, an example of which is explained in greater detail below.

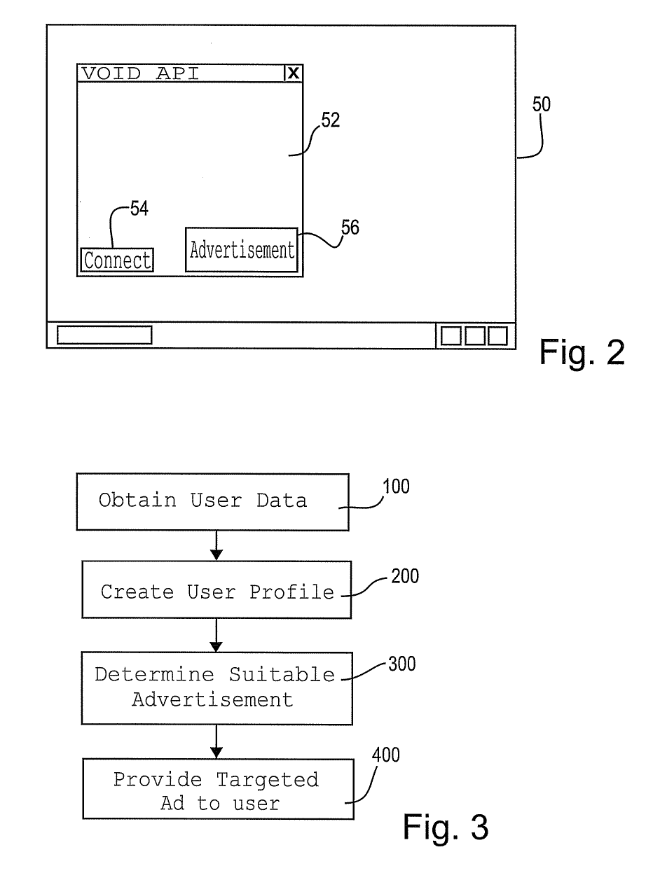

User A and User B interact with PCs 18 and 20 using a graphical user interface (GUI) 50 shown in FIG. 2. The GUI 50 is provided by an operating system residing on PC 18 or 20 and is used to execute and interact with various software programs. In FIG. 2, a VoIP application program interface (API) 52 is provided by the GUI 50 for connecting, e.g., User A, to a VoIP service provided by the telecommunication system 16. The API 52 comprises a connection option 54 for connecting the user to the telecommunication system 16 through the network 14, and an advertisement portion 56 that is dedicated to displaying advertising content to User A. It will be appreciated that the APT 52 is typically proprietary software distributed by the telecommunication system 16 and uses conventional means for providing a gateway to the Internet-based service.

User A is capable of communicating with User B over the network 14 using the VoIP service provided by the telecommunication system 16. In this example, the administrator 28 provides the VoIP service to User A at a considerable discount, e.g. free, in exchange for the opportunity to compile information related to User A that can be used to generate one or more identifier that indicates User A's relevance to a particular category, that is in turn used by the advertising system 30 to provide a targeted advertisement to User A within the advertisement portion 56.

Referring now to FIG. 3, in general, the advertising system 30 obtains data pertaining to the users at step 100, creates a user profile for each user that is registered with the system 30 at step 200, determines suitable advertising content for the particular user at step 300, and provides a targeted advertisement to the user at step 400.

The data pertaining to the users, e.g. User A, may be obtained in step 100 using various means. For example, User A agrees to provide personal data upon registering with the telecommunication system 16 for VoIP service. Preferably, User A is requested to provide information such as name, language, ethnic background, gender, interests, occupation, marital status, geographical information, educational background etc, in exchange for a discounted rate for using the VoIP service or for free. User A also agrees to allow the advertising system 30 to analyze information related to them for providing targeted advertising in order to cover the cost associated with offering the discounted rate.

In addition to, or instead of, requiring User A to enter such personal information, the advertising system 30 may also, with the appropriate permission, acquire data and build a personal profile based on conversations between User A and a called number, e.g. that for User B. For example, the advertising system 30 records details of the VoIP communication and later analyzes the content of the communication to extract useful information related to User A. In such a scenario, the advertising system 30 utilizes predetermined criteria to make its own determination regarding a user's interests and, using voice recognition software, may also determine the gender and likely age category for User A without inconveniencing them with the task of entering the data.

In yet another alternative, the advertising system 30 may also utilize information that was used to register for the VoIP service and/or to register the API software 52 when the service is installed. It will be appreciated that any means may be used to acquire the necessary information regarding User A, the choice of which typically depends on the type of service being provided and the relationship between the customer and the administrator 28.

The data pertaining to each user is preferably acquired prior to using the service, however, the data may also be gathered in real-time, preferably while the user first uses the service in order to build and update a user profile for later use.

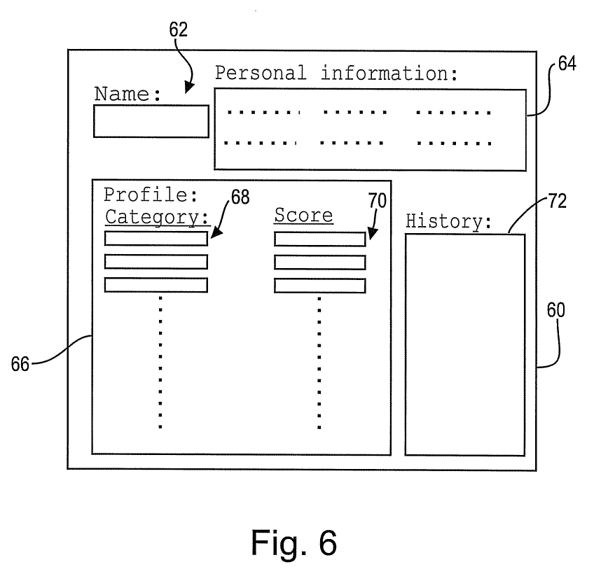

A exemplary user profile 60 is shown pictorially in FIG. 6. The profile 60 comprises a name indicator 62 and personal information 64 regarding the user, as well as a profile 66 that includes identifiers for the user, such as a score 70 for each of a number of market categories 68 stored in the market database 36. Each profile 60 is preferably stored as a database entry in the user database 32. The profile 60 also contains a history log 72 for tracking the activity of the particular user. The history 72 may also be used to further distinguish certain advertising content from others.

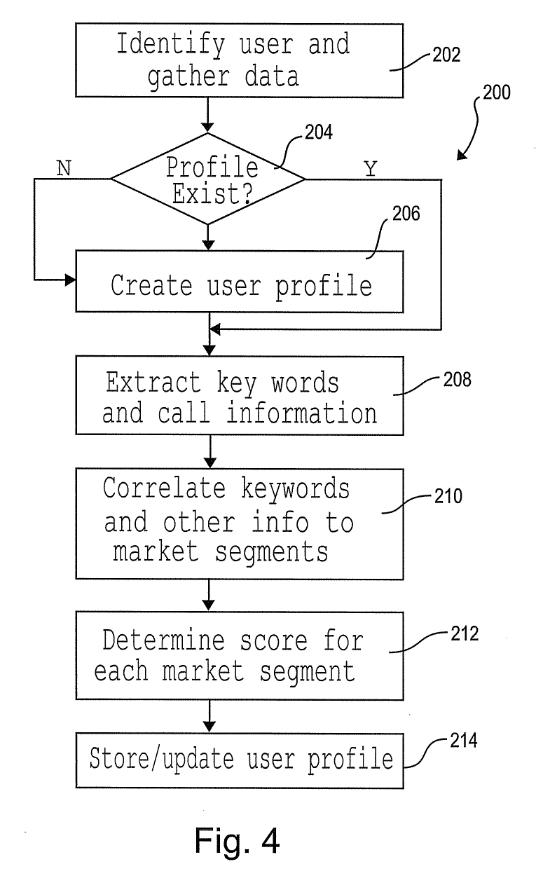

An exemplary set of steps for building a user profile 60 is shown in FIG. 4. It will be appreciated that the following describes one example and is used for illustrative purposes only.

In addition to obtaining information regarding users (i.e. step 100), the advertising system 30, in conjunction with the server 26 and/or administrator 28, also identifies the particular user when they attempt to use the service. For example, the originating telephone number or Internet Protocol (IP) address is used to identify a particular entity and/or location such as a household or place of business and voice recognition software is used to identify a particular user at that location. In the present example, User A first attempts to register for free VoIP service by loading and running the API 52. When User A attempts to connect using the connect option 54, the API 52 runs a registration module (not shown) to acquire data from User A. Preferably User A provides their name 62 and some personal information 64 at step 202 that can be used to identify them as User A in subsequent connections. This may include having an auditory sample recorded for voice recognition. Alternatively, the API 52 allows User A to connect for a certain period of time that is sufficient to allow the advertising system 30 to gather enough data to generate a profile 60.

The first connection attempt by User A will also preferably require that User A agree to having their communications analyzed in exchange for the VoIP service. At step 204, the advertising system 30, using the APT 52 running on the PC 18, determines if User A has a profile 60. This can be performed using a message sent from the API 52 to the advertising system 30 when the connection option 54 is first used, or can be performed by the advertising system 30 cross-referencing an IP address or telephone number with a user name 62. If a profile 60 for User A does not exist (e.g. at registration time) then an empty user profile 60 is created at step 206. At this time any information that is available to the advertising system 30 can be added to the profile 60. If a profile 60 does exist then the advertising software 30 bypasses step 206 and initiates a VoIP connection for User A.

User A then uses the API 52 to make a call to User B. It will be appreciated that User B does not need to subscribe to a VoIP service to receive a call. Preferably, the advertising system 30 will, in addition to using information 64 provided by User A, monitor the call made by User A, and a portion of the conversation, in order to determine the nature of the call. User B may be associated with a particular commercial sector, e.g. a car dealership and thus this information can be used by the advertising system 30 to determine whether or not User A is likely to be interested in servicing, buying or leasing a car. Therefore, the advertising system 30 also preferably records the beginning of the conversation and using voice recognition software extracts keywords from the conversation in order to narrow the number of relevant categories 68 at step 208. For example, User A calls User B and asks if their car can be dropped off for service. If the keywords “car” and “service” can be distinguished from the conversation using the voice recognition software they can be correlated to categories 68 such as “car servicing”, “car leasing” or “car buying” that are stored in the market database 36.

Based on this information, a score 70 can be calculated at step 212 saved in the user profile for the category “vehicle” at step 214. The score reflects how relevant an advertisement is likely to be to the user and how relevant it may be at that time. The user profile 60 and market data that is collected is used to calculate the score 70. In addition, the words and patterns of words detected during the telephone conversation are also considered. The score 70 can be calculated based on various methods that utilize pattern recognition, in order to correlate the user to one or more particular market category 68. Pattern recognition algorithms that are capable of teaching the advertising system 30 how to calculate the score 70 can also be used. The algorithm used to calculate the score 70 can be as simple as counting the number of times particular keywords are detected, or can be as sophisticated as such a pattern recognition algorithm with learning capabilities. It will be noted that any suitable algorithm can be used and that the choice of which algorithm is implemented is dependent on the nature of the application and the desired accuracy for the results.

The value indicated by the score 70 enables the advertising system 30 to determine the likelihood that User A would be interested in advertisements related to that category 68. Typically the score 70 from each category 68 is used to assemble a advertisement queue from the highest score to the lowest score (excluding zeros).

In this example, a commercial or advertisement related to a vehicle would be given a relatively high score. The advertising system 30 would also gather other data pertaining to User A, based on other conversations and/or their existing profile 60. For example the age and occupation of User A could be used to determine a particular model of car in a particular price range. A score 70 for each category 68 is calculated (default zero) in step 212 and the user profile 60 for User A updated accordingly at step 214.

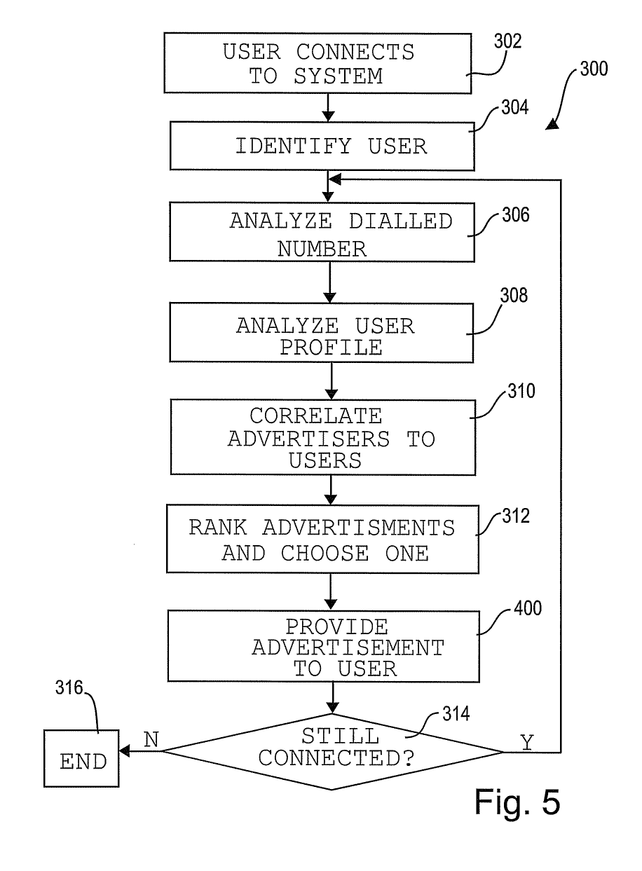

Referring now to FIG. 5, step 300 of FIG. 3 is described in greater detail. User A first connects to the telecommunication system 16 at step 302 to make a phone call using the API 52. Preferably, the steps outlined in FIG. 4 have been completed such that a user profile 60 already exists. User A then calls User B to inquire regarding a vehicle they have dropped off for service. At step 304, User A is identified by the advertising system 30 based on their IP address and preferably the dialled number for User B is analyzed at step 306. The dialled number is used to narrow and/or re-prioritize the advertising content. The advertising system 30 can use a reverse look-up to determine the place of business. If this cannot be determined, e.g. a private number is used, then this data may be ignored.

At step 308, the advertising system 30 analyzes the profile 60 for User A and determines a number of potential commercials and banner advertisements that could be provided to User A at step 310 based on any non-zero score 70 given to a respective category 68. Preferably, the dialled number is used to narrow the choices to vehicle-related advertisements, which are given priority and then ranked in order based on score 70, to develop an advertising queue at step 312. The advertisements are then presented in order of priority using the advertisement portion 56 at step 400 (shown in both FIG. 5 and FIG. 3) during a period of time that User A is making use of the telecommunication system 16.

The advertisements can be presented to User A during a call, just before a call, as the call is being initiated, or at the end of the call. The advertising system 30 may also store a list of competitors for particular dialled numbers and upon User A dialing such numbers, prioritize advertisements related to the competitors. In such cases, the advertising system 30 can establish a relationship with certain advertisers in order to provide varying levels of service for varying remuneration. Similarly, coupons or other “deals” can be presented based on the nature of the agreement with the particular advertiser. Typically, the advertisements comprise one or more of an image, video and audio file that can be presented within the API 52 or another portion of the GUI 50. The advertisement can also be displayed or played as part of a streaming audio or video on the devices. In that case the advertisements would be inserted at places where it is indicated to be inserted. If the device is used by several users, the profile of the most used user or the category of the household would be used to determine what ad to play.

The advertisement/special messages could also be recorded in the advertisement server remotely through a PC/Phone or any other devices that can be used for communication and the category the message should be targeted can be entered by the recorder or the system would identify the category by recognizing the recorder by getting the user to enter a password to enter into the advertisement server to record the message. The advertisement server could also be programmed by the advertiser through PC, phone and other devices the preference on when the message should be broadcasted (real time, as soon as possible, between such and such time, whenever user use the phone).

The administrator will also have the flexibility to put the formula for selecting the advertisers based on the user or household. For example, he can set that for certain users (by any indicator) certain advertiser or person leaving special message will have preference over all the other advertisers in terms of priority.

The user itself can also indicate the priority in terms of advertisement or special messages that he/she likes to get on his/her devices. The user will also have the flexibility to choose what music he likes to listen to on the streaming and what messages or advertisement will have what kind of priority (during certain time, when available or at request by dialing a number in the device). The user can rewind, forward or skip the streaming audio or advertisement by pressing a number on the phone.

All the advertisers' phone numbers would also be stored in the system, so that whenever a user calls those numbers, it would be recorded as to how many times it was called, whether it was connected and how long the call lasted. This can also be used to charge advertisers on per call basis. The users calls to identified competitors number would also be recorded for market analysis.

Preferably, after each advertisement is presented, the advertising system 30 then determines if User A is still connected at step 314 and if not, the application ends at step 316. If User A is still connected then the next advertisement in the queue can be presented. Preferably, the advertising system 30 will accept additional user information entered by User A using the API 52 and/or continuously monitors the content of the conversation between User A and User B and other dialled numbers and update the profile accordingly. In this case the advertising system 30 re-evaluates the priorities for each targeted advertisement and adapts to changes in the user profile in real time.

For example, User A completes a call with User B and then dials another number associated with another user (not shown). If this other user is not also associated with a vehicle then the priority given to vehicle-related categories is removed and the categories re-evaluated. The conversation with the other user may relate to a different category-type such as real estate, in which case the vehicle-type categories are no longer of priority but financial, mortgage and other real estate categories are of priority.

Therefore it is seen that the advertising system 30 can continuously refine and develop the user profile 60 based on both historical data 72 and current data in order to provide the best possible match between user and advertising content.

In another embodiment, the service provided by the telecommunications system 16 is a standard Internet connection to the world wide web, in which case, website addresses are used similar to the dialled numbers discussed above to further narrow the advertisement choices.

It will be appreciated that the above principles can be applied to other telecommunications systems 16 such as those for mobile phones, conventional telephone lines, and mobile email devices, whereby advertising content is displayed on a display screen provided by the device. Therefore, any communication system that can display information in one or more of an audio, a video and a textual format can be linked with the advertising system 30 to target advertising to a particular demographic.

The user can connect to the system by dialing a given phone number through any devices including cell phone, home phone or VOIP phone that works on Wi-FI or WI Max. The user can also connect to the system any other ways including using a Callerid Call-back method as described in Canadian Patent application No. 2,464,815 and herein incorporated by reference. Once the user is connected to the system, he can use any services provided by the system including listening to a streaming radio, discounted or free local and long distance calls, Voice Smiley as described in Canadian Patent Application No. 2,474,083 and herein incorporated by reference and others. The services might be provided free or at a discounted rate in return for allowing commercials. The commercials can be an audio file that is played before, during or after the service is used. The commercial can be video or text that is sent to the display of the phone, cell phone or communication devices that is used to access the service.

Although the invention has been described with reference to certain specific embodiments, various modifications thereof will be apparent to those skilled in the art without departing from the spirit and scope of the invention as outlined in the claims appended hereto.

What is claimed is:

1. A method for providing advertising to a user in a telecommunication system, the method comprising:
obtaining information related to said user;
assigning one or more identifier to said user based on the nature of said information;
identifying an advertisement applicable to said user based on at least one of said one or more identifier; and
providing said advertisement to said user using said telecommunication system.

2. A method according to claim 1 wherein said obtaining information comprises recording a communication made by said user using said telecommunication system.
